(19) United States
(12) Patent Application Publication
(10) Pub. No.: US 2009/0096131 A1
(43) Pub. Date: Apr. 16, 2009

(54) METHOD OF MAKING A COMPOSITE PRODUCT

(76) Inventor: Neil Edwin Wallace, New South Wales (AU)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/159,575

(22) PCT Filed: Dec. 28, 2006
(86) PCT No.: PCT/AU06/01960

§ 371 Date: Oct. 23, 2008

(30) Foreign Application Priority Data
Dec. 29, 2005 (AU) 2005907332
Oct. 9, 2006 (AU) 2006905593
Oct. 9, 2006 (AU) 2006905594

(51) Int. Cl. B29C 39/00

(52) U.S. Cl. 264/241

(57) ABSTRACT

A method of forming a polymeric component (41, 50, 51, 55) on a body (100, 200, 400) provides an open mould (501, 502) having an inner surface (503, 504). The mould is placed onto a surface (401) of the body (400 so that a closed cavity (505) is formed by the inner mould surface and the body surface. A fluid polymeric material is introduced into the closed cavity which is caused to harden to form the polymeric component as a casting on the body.

### FIELD OF THE INVENTION

The present invention relates generally to a method of making composite products. The invention has particular application to composite products that include a polymeric component that is formed on a body which is typically metal. The invention is described with reference to composite products for water infrastructure (such as pipes, channels, water detention or retention systems, and tanks). However, it is to be appreciated that the invention has broader application and is not limited in that use.

### BACKGROUND OF THE INVENTION

It has been found beneficial in at least some instances to form products such as water infrastructure products, as a composite construction where a polymeric component is connected to the metal section. This component may serve a variety of purposes. For example, the component may provide at least part of a coupling to allow the section to be connected to another section forming a watertight seal at the coupling. In another example, the polymeric component may be used as part of a base or lid structure for a water tank or detention/retention system.

### SUMMARY OF THE INVENTION

In a first aspect the invention provides a method of forming a polymeric component on a body, the method comprising the steps of:

providing an open mould having an inner surface;

placing the mould onto a surface of the body so that a closed cavity is formed by the inner mould surface and the body surface;

introducing a fluid polymeric material into the closed cavity; and

providing conditions suitable to cause hardening of the polymeric material to form the polymeric component as a casting on the body.

In accordance with this invention, the polymeric component is formed as a casting onto the body surface. Such an arrangement has substantial practical benefit in that it can simplify the manufacturing of the product. Further, because the polymeric material is introduced as a fluid onto the section surface, the surface of the component can match the surface of the body even when that surface is profiled to incorporate stiffening ribs or the like.

In the context of the specification, the term “cast” or variations such as “casting” and the like as used in relation to the polymeric components includes all moulding techniques and/or resulting articles formed by such techniques, where the polymeric material is introduced into a mould so as to form the component into a particular shape.

In one form, the method further comprises the steps of controlling the pressure that the fluid polymeric material is introduced into the cavity to below a first threshold and then subsequently increasing the pressure of the fluid above the first threshold. This approach has the advantage that it can be used in circumstances where the section surface is not able to withstand the high pressures usually associated with injection moulding techniques. As an example, where the body is formed from sheet metal, the pressure of the fluid polymeric material that is introduced may be in the order of 200 to 500 kpa.

In one form, the pressure within the cavity is increased by promoting expansion of the polymeric material in the cavity.

In one form this is achieved by introducing a chemical blowing agent into the cavity to cause expansion of that polymeric material. In one form, this process causes the polymeric component to have a more peripheral skin as compared to an inner core of that component. This further has the advantage of reducing material cost and weight of the polymeric component.

In one form, the method further comprises the step of causing the fluid polymeric component to bond with the body surface. In one form, the body surface is polymeric and the method further comprises the step of heating the surface to promote bonding between the body surface and the polymeric component. In a particular form, the body is preheated to heat the body surface. In addition or alternatively, the polymeric material may be introduced into the cavity at an elevated temperature to cause heating of the body surface.

In a particular embodiment, the body is heated to cause the polymeric surface to become tacky so as to promote bonding between the component and that surface.

In a particular arrangement of the above form, the body incorporates a substrate and polymeric film that is applied to that substrate to form the polymeric body. In a particular form, that substrate is formed from metal and in one form is formed from sheet metal preferably sheet steel.

In yet a further embodiment, the method further comprises the step of forming a fluid seal between the mould and the body by causing rapid hardening of the fluid polymeric material in the region of the join between the mould and the body. In a particular arrangement, this rapid hardening of the polymeric material is caused by increasing the rate of cooling at that region of the join. In an alternative arrangement, a fluid seal is formed between the mould and the body by introduction of the gasket disposed between the mould and that body.

In one form, the polymeric component is cast as a preform onto the body. In that arrangement the method further comprises the step of post forming the preform into its finished shape. In an alternative arrangement, the polymeric component is cast into its finished shape directly without requiring any post forming.

In yet a further embodiment the body is profiled so that the interface between the polymeric component and the body is tortuous.

In a further aspect, the present invention provides a composite product comprising a hollow body, and a polymeric component cast onto a surface of the body.

In one form, the component is bonded to the body surface as a result of being cast onto that surface. In a particular form, the bonding between the component and the section surface provide a fluid seal between the body and the component.

In one form, the body is formed from sheet metal and in a particular form is made from sheet steel that incorporates a corrosion resistant metal coating.

In a particular form where the component is bonded to the body surface, the product may further comprise an intermediate layer between the body and the polymeric component which aids in that bonding process. In one form, that intermediate layer is introduced during casting of the component onto the product. In another form, the layer is introduced prior to casting.

In a particular form, the intermediate layer is applied to the metal where the body is formed from metal prior to casting of the component and forms a polymeric coating on the metal. In a particular form, this polymeric coating is in the form of a polymeric film. The polymeric film not only aids in bonding of the component to the section but may be used for other purposes. For example the polymeric film may provide a moisture barrier and/or enhance the chemical resistance of the metal. Such polymeric films may include low density or high density polyethylene, PVC and polypropylene. One suitable polymeric film is sold under the trade mark TRENCHCOAT™ LG. Another PVC coated steel sheet product used in water infrastructure products is sold by the applicant under the trade mark AQUAPLATE™.

In one form, the body surface on which the polymeric component is cast is profiled. This profiling may take various forms and may be comprised of stiffening formations such as corrugations, ribs or the like which are provided to increase the structural properties of the section. Alternatively or in addition, the surface may be profiled to improve the fluid seal between the section surface and the component by providing a torturous path at the interface to restrict the penetration of water through that interface. Furthermore, the profiling of the section surface may additionally, or alternatively improve the connection between the component and the body surface by creating a mechanical interference that effectively keys those two parts together.

The provision of a physical barrier to fluid penetration through the interface and/or the creation of a mechanical interference may be improved by injecting the polymeric material into the casting mould under pressure and/or by controlling shrinkage of the component onto the surface of the body as it cools after casting.

In one form, product is for water infrastructure and the body is in the form of a pipe with a closed section. In a particular form, the pipe includes at least one external rib which extends between opposite ends of the pipe. Once such pipe that is formed from steel incorporating the TRENCHCOAT™ LG film is manufactured and sold by the applicant under the trade mark HYDRORIB™.

In one form, the component is cast onto the pipe so as to form a coupling for that pipe. In one form, the coupling is formed at the end of the pipe. Alternatively it may be formed at an intermediate section of the pipe to provide a branch coupling for that pipe.

It is to be appreciated that because the polymeric component is cast onto the body surface there is a great deal of flexibility into the shaping of that component. Further, whilst in one form the component may be cast into its final shape, in an alternative arrangement, the component may be cast as a preform which may then be subsequently processed (such as by a milling operation) to shape the component into its final shape.

### BRIEF DESCRIPTION OF THE DRAWINGS

It is convenient to hereinafter describe embodiments of the present invention with reference to the accompanying drawings. It is to be appreciated that the particularity of the drawings and the related description is to be understood as not limiting the preceding broad description of the invention.

In the drawings:

FIGS. 1A, 1B and 1C are schematic views of various pipe couplings incorporating polymeric components used in water infrastructure;

FIG. 2 is a schematic view of a branch junction for a pipe;

FIG. 3 is a schematic sectional view of a water tank incorporating a polymeric base coupling;

FIG. 4 is a schematic side view of a moulding apparatus connected to an end of a host section;

FIG. 5 is an end view of the moulding apparatus of FIG. 4;

FIG. 6 is a schematic sectional view of the moulding apparatus connected to the host section, where that section has an external ribbed configuration;

FIG. 7 is a variation of the view of FIG. 6 where the host section is corrugated;

FIG. 8 is a further variation of a pipe coupling of FIG. 1C in an exploded view;

FIG. 9 is an assembled view of the pipe coupling of FIG. 8; and

FIG. 10 is a sectional view of the pipe coupling of FIG. 8.

### DETAILED DESCRIPTION OF THE DRAWINGS

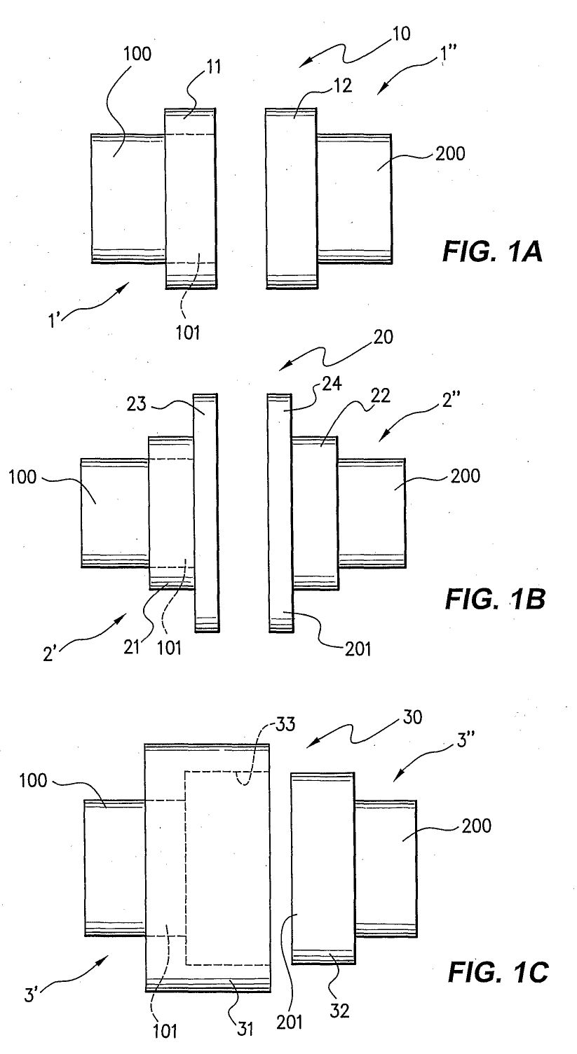

FIGS. 1A to 1C illustrate various couplings 10, 20 and 30 for connecting first and second pipes 100 and 200. The couplings incorporate polymeric components which are moulded to ends of the pipe as will be described in more detail below.

In the illustrated form, the pipes 100 and 200 are formed from sheet steel that incorporates a corrosion resistant coating. Further, the steel may be profiled to include stiffening formations so as to increase the strength of the pipe. These stiffening formations may be in the form of ribs, corrugations or the like. Furthermore, the pipes 100 and 200 may be coated with a polymeric material. This polymeric material may be in the form of a film that provides a moisture barrier and/or enhances the chemical resistance of the sheet metal. Such polymeric films may include low or high density polyethylene, PVC and polypropylene. Further, the polymeric film may facilitate bonding of the polymeric components to the respective pipes.

An example of a pipe that is formed from sheet steel strip that includes external ribs that extend helically along the pipe is sold by the applicant under the trade mark HYDRORIB. This pipe incorporates an LD polyethylene film coating sold under the trade mark TRENCHCOAT™LG and is formed by a process of spiral winding the steel strip.

The pipes 100, 200 are arranged to be connected through the couplings 10, 20 and 30 in end to end relationship and in a watertight manner so as to be able to convey water over indefinite lengths. The infrastructure provided by the pipes 100, 200 may be pressure rated so as to supply town water or water for irrigation or may be non-pressurised and used in applications such as culverts or storm water. The efficacy of the seal formed by the couplings 10, 20 or 30 dictate largely the pressure rating of the pipes.

In the embodiment illustrated in FIG. 1A, the coupling 10 incorporates a first polymeric coupling 11 formed at the end of the first pipe 100 and a second polymeric coupling 12 formed at the end of the other pipe 200. These couplings are arranged to abut one another to form a butt connection between the pipes 100 and 200. A clamping element (not shown) may be disposed over the couplings so as to retain them in position.

In the embodiment illustrated in FIG. 1B, a first coupling 21 is formed on the pipe end 101 whereas a second coupling 22 is formed on the end 201 of the second pipe 200. Each of the couplings include a flange (23, 24 respectively) at its outer end and these flanges are arranged to butt together in connection of the coupling 20. Whilst not shown, typically fasteners, such as a nut and bolt, extends through the flanges 23 and 24 to maintain the pipes together.

In the embodiment in FIG. 1C, the coupling 30 is of a bell and spigot type with the bell 31 being formed on the end of the pipe 100, and the spigot 32 formed on the end of the other pipe 200. Location of the spigot 32 into the cavity 33 of the bell 31 connects the pipes 100 and 200 together and effects the seal therebetween.

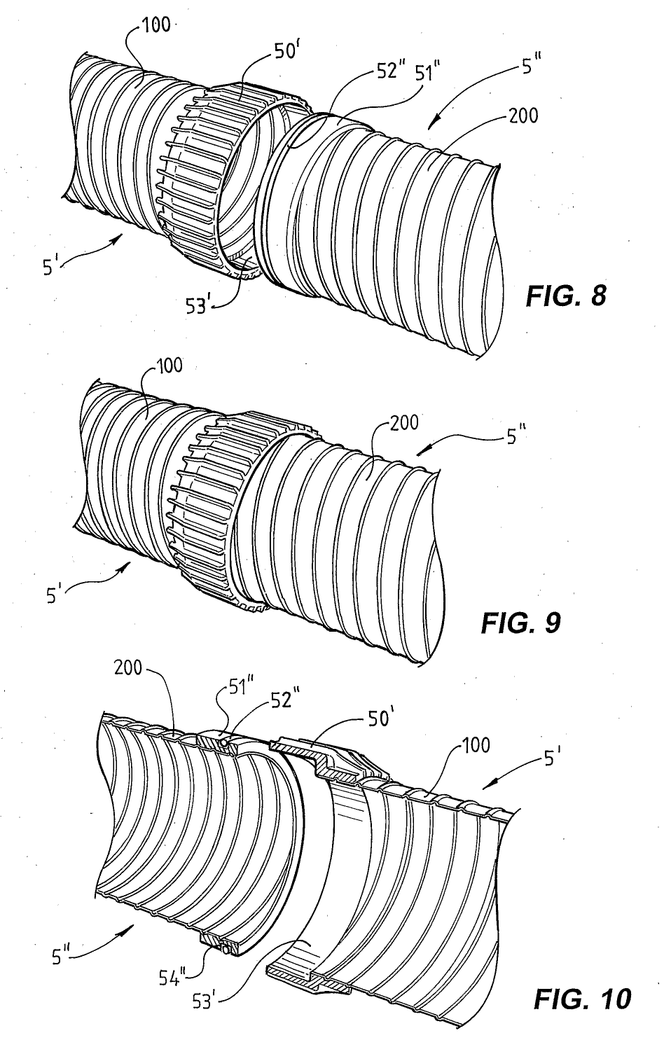

The embodiments of FIGS. 1A to 1C illustrate general coupling types which are ideally formed from polymeric components. As will be appreciated by those skilled in the art, it may be necessary to incorporate seals such as “O” ring seals or pressure seals to provide a watertight joint. An example of such an arrangement is shown in FIGS. 8 to 10.

In the embodiment of FIGS. 8 to 10, a first coupling element (bell) 50^{I} is disposed on the end of one pipe 100 and forms the female component whereas the other coupling element (spigot) 51^{II} is disposed on the end of the other pipe 200 and forms the male connection. A pressure seal 52^{II} is disposed on the male component 51^{II} and is designed to engage with an internal surface 53^{I} of the female component 50^{I}. The pressure seal is set partly into a recess 54^{II} formed in an outer surface of the male component 51^{II}.

A watertight joint is formed by locating the male component 52^{II} into the bore 53^{I} of the female component 50^{I}. The pressure seal 51^{II} forms the watertight seal and is designed to move into tighter engagement with the coupling elements 50^{I} and 51^{II} under increased pressure in the pipes thereby not only increasing the seal but also inhibiting inadvertent release of the pipes. This obviates the need for any separate clamping element to keep the pipe lengths 100, 200 axially aligned.

In addition to the seal formed between the coupling elements, the effectiveness of the coupling to be watertight will depend to some extent on the interface between the respective polymeric component and the host pipe. The provision of this watertight interface between these parts will be described in more detail below.

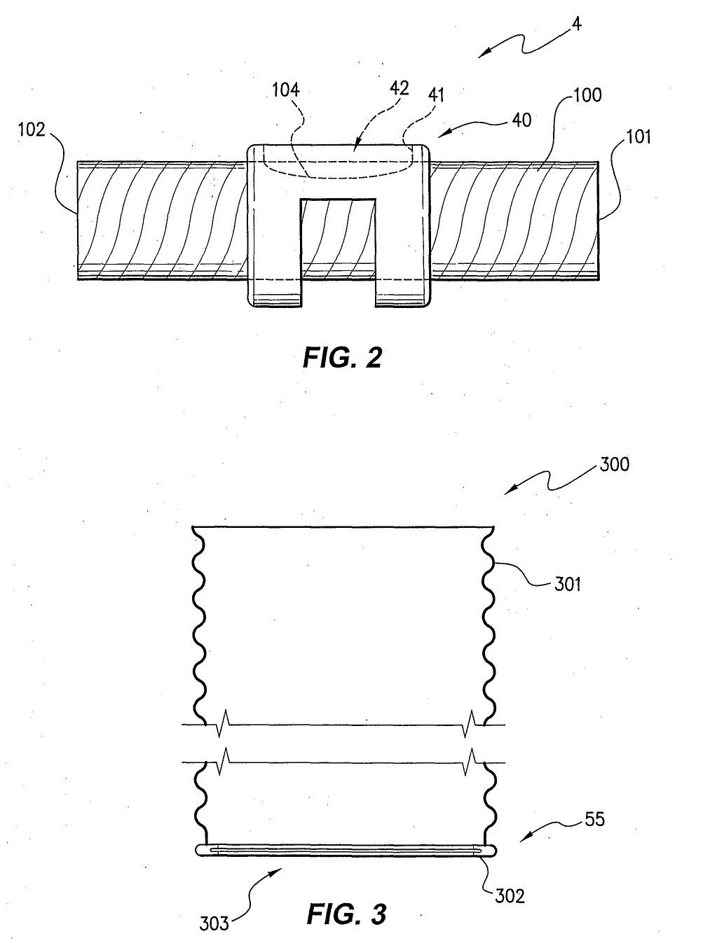

FIG. 2 illustrates a further variation of coupling 40 for a host pipe 100. In this embodiment, the coupling 40 is used to provide a branch line to the pipe 100 and as such, is formed intermediate the ends (101, 102) of the pipe 105. In the illustrated form, the coupling 40 forms a polymeric collar 41 which projects from the pipe surface. This collar 41 defines a central cavity 42 in which an aperture 104 in the underlying pipe wall is located. With this arrangement, a second pipe having a suitable coupling on its end can be connected into the pipe 100 at the coupling 40.

Whilst in one form the coupling 40 may be formed offsite, in an alternate arrangement the coupling may need to be made onsite on an already laid pipe. In that arrangement, the polymeric component 41 is moulded onto the pipe wall, and the aperture 104 is tapped into the pipe onsite.

FIG. 3 illustrates a further type of water infrastructure product, namely a water tank 300. In the embodiment of FIG. 3, the water tank 300 is formed with a cylindrical wall 301 which is made from a profiled sheet metal strip. Again this sheet metal strip may be sheet steel which incorporates a corrosion resistant metal coating and typically incorporate a polymeric coating. An example of a suitable PVC coated sheet steel strip is sold by the applicant under the trade mark AQUAPLATE™. The sheet metal strip may be profiled with corrugations or ribs and the tank wall may be made from a spiral winding of the sheet strip or in a more conventional configuration, the tank wall is built up by a series of cylindrical panel elements which are disposed one on top of the other.

In the embodiment of FIG. 3, the tank incorporates a polymeric component 55 which is cast onto the bottom of the tank wall 302. This polymeric component forms part of a base assembly 303 for the tank 300.

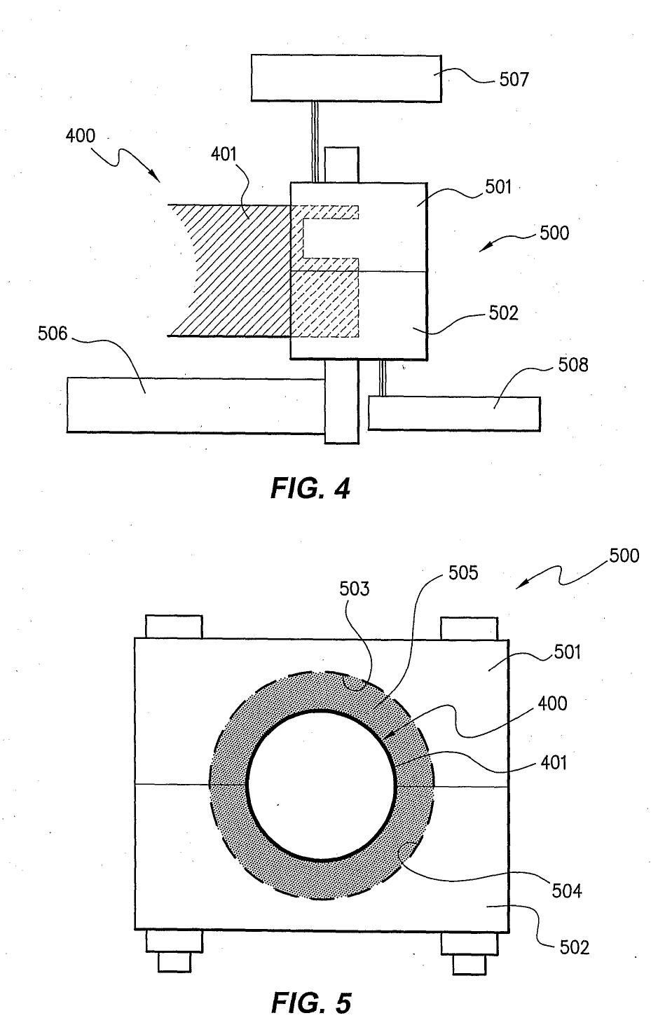

In each of the embodiments illustrated above, the polymeric components are cast directly onto the product section 100, 200 or 300. FIGS. 4 to 7 illustrate this process of casting in more detail.

Turning firstly to FIGS. 4 and 5, to cast the components onto a product section 400, a moulding apparatus 500 is provided which incorporates mould shells 501 and 502 which clamp around the product section 400. The mould shells 501, 502 each have an interior mould wall 503 and 504 which when clamped to the product section 400 form, in conjunction with an outer surface 401 of the host section, a closed cavity 505 in which the polymeric material can be introduced.

The apparatus 500 further comprises a feed assembly 506 for introducing the polymeric material into the mould cavity 505. This assembly is typically in the form of an a extruder/injector system which introduces the polymer material in a liquid form under relatively low pressure (typically in the order of 210 kpa-480 kpa) so as not to deform the product section 400. Furthermore, single or multiple injection paths may be used to combine the properties of one or more polymers or other extruded materials to create both a homogenous or heterogenous structures that have an influence upon the physical properties and economics of the final moulded component.

Typically injected polymeric material may be derived from resins associated with polyolefin, ethylene vinyl acetates, poly vinyl chloride, polypropylenes, polycarbonates, nylon and associated blends. These polymeric materials may in addition or alternatively comprise rubber related compounds and may or may not be reinforced by the addition of ceramic or glass beads, directional fibres and/or solid inserts manufactured from polymer for metallic components. The composition of the polymeric material may vary as will be appreciated by persons skilled in the art and as such is outside the scope of the invention.

To control the operating parameters of the moulding process, the host section 400 and/or the mould shells 501, 502 may be heated to aid the particular polymer flow characteristics. Typically this will be done via a mould heat apparatus 507. Further, these components may be selectively cooled (by apparatus 508) to control the material flow and shrinkage of the moulded component. In one form, the mould and/or the pipe is cooled to room temperature over a period, typically of less than 15 minutes. Further, a fluid seal may be formed between the mould as the section surface by rapid cooling of the polymeric material in the region of that join. Alternating a fluid seal may be provided by the use of a gasket of the join.

In addition, gases and or other chemical blowing agents may or may not be added to the polymer material either at the time of formulation or at the point of injection of the polymer to the mould to increase the pressure within the mould to enable the polymeric material to fully take up the shape of the cavity and to control shrinkage of the moulded part and/or the specific filling characteristic of the polymers and the mould cavity.

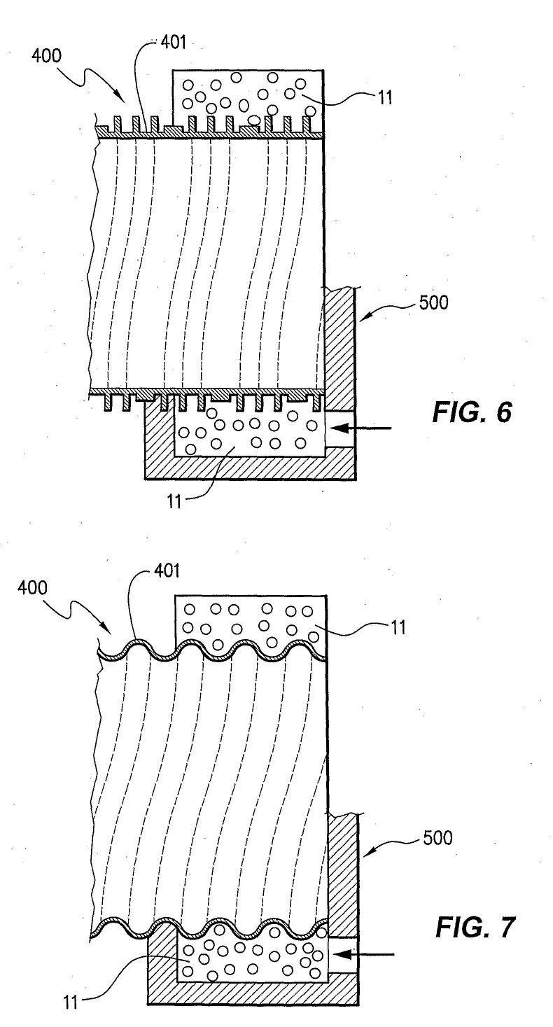

FIGS. 6 and 7 schematically illustrate the moulds 500 shown in the embodiment of FIG. 6, when connected to an externally ribbed smooth bore steel pipe whereas in FIG. 7 the host section 400 is a corrugated pipe.

In view of the direct casting of the polymeric component 11 onto the host surface 401 it is possible for the component to precisely take up the shape of that surface so that it is intimately in contact with that surface substantially along the entire interface between those parts. This substantially improves the effectiveness of the interface or joint between these parts to prevent water penetration.

In one form, by choosing appropriate materials, it is possible to achieve a strong bond between the polymeric component and the host section. In one form the polymeric material may bond directly onto a metal surface. Alternatively, the pipe may be pre-coated with a polymeric coating such as that described above so as to enable that coating to bond with the polymeric material of the component. In that arrangement, the coating is heated to become tacky to assist in formation of the bond between the section and the component. Typically the coating is heated in the range of 90° to 180° and more preferably about 130°.

In addition, if the host section 400 has a profiled outer surface, as illustrated in FIGS. 6 and 7, then the casting of the polymeric components onto that surface provides a mechanical interference which both improves the strength of the connection and also creates a torturous path which can aid in inhibiting water penetration through the interface between the parts. This mechanical interference may be improved by the polymeric component shrinking during cooling after it is cast.

By casting the components onto the host section, it can obviate or at least substantially reduce the need to further shape the components after they have been cast. However, it is to be appreciated that if some complex shapes are required, then some post forming may be necessary. However, in many instances no post forming will be required. This not only provides the advantage of simplifying the process for forming the components and also the equipment that is necessary, but also provides an arrangement where the components can be cast onsite. This is particularly advantageous in water infrastructure where new sections of channels or pipes may be need to be installed and/or new connections made.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Variations and modifications may be made to the parts previously described without departing from the spirit or ambit of the invention.

1. A method of forming a polymeric component on a body formed of sheet material, the method comprising the steps of:
providing an open mould having an inner surface;
placing the mould onto a surface of the body so that a closed cavity is formed by the inner mould surface and the body surface;
introducing a fluid polymeric material into the closed cavity;
controlling the pressure that the fluid polymeric material is introduced into the cavity to be below a first threshold level; and
subsequently increasing the pressure of the fluid polymeric material in the cavity above the first threshold level; and
providing conditions suitable to cause hardening of the polymeric material to form the polymeric component as a casting on the body.

2. A method according to claim 1, wherein the pressure of the polymeric material in the cavity is increased by promoting expansion of the polymeric material.

3. A method according to claim 1, wherein the first threshold level is in the range of 200 kpa to 500 kpa.

4. A method according to claim 1, wherein the pressure of the fluid polymeric material in the cavity is increased by introducing a chemical blowing agent into the cavity.

5. A method according to claim 1, wherein the polymeric component formed has an outer skin and a core and wherein the outer skin is denser that the core.

6. A method according to claim 1, further comprising the step of causing the fluid polymeric component to bond with the body surface.

7. A method according to claim 1, wherein the body surface is polymeric and the method further comprises the step of heating the body surface to promote bonding between the body surface and the polymeric component.

8. A method of forming a polymeric component on a body having a polymeric surface, the method comprising the steps of:
providing an open mould having an inner surface;
placing the mould onto a surface of the body so that a closed cavity is formed by the inner mould surface and the body surface;
introducing a fluid polymeric material into the closed cavity;
heating the body surface to promote bonding between the body surface and the polymeric fluid material; and
providing conditions suitable to cause hardening of the polymeric material to form the polymeric component as a casting on the body.

9. A method according to claim 8, wherein the body is preheated to heat the body surface.

10. A method according to claim 8, wherein the fluid polymeric material is introduced into the cavity at an elevated temperature to cause heating of the body surface.

11. A method according to claim 8, wherein the body is heated to cause the polymeric surface to become tacky.

12. A method according to claim 8, wherein the body incorporates a substrate and a polymeric film that is applied to the substrate to form said polymeric body surface.

13. A method according to claim 1, wherein the body is at least partially formed from metal.

14. A method according to claim 12, wherein said body substrate is formed of metal.

15. A method according to claim 1, further comprising the step of forming a fluid seal between said mould and said body surface by causing rapid hardening of the fluid polymeric material in the region of the join between the mould and the body surface.

16. A method according to claim 15, wherein the rapid hardening of the polymeric material is caused by having an increased rate of cooling of the fluid polymeric material in the region of the join between the mould and the body surface.

17. A method according to claim 1, wherein a gasket is disposed between said mould and said body surface to cause a fluid seal therebetween.

18. A method according to claim 1, wherein the polymeric component is cast onto the body into its finished shape.

19. A method according to claim 1, wherein the polymeric is cast as a pre-form onto the body and the method further comprises the step of post forming the pre-form into its finished shape.

20. A method according to claim 1, wherein the polymeric component forms a coupling for the body.

21. A method of forming a polymeric component in the form of a coupling on a body comprising the steps of:
providing an open mould having an inner surface;
placing the mould onto a surface of the body so that a closed cavity is formed by the inner mould surface and the body surface;
introducing a fluid polymeric material into the closed cavity; and
providing conditions suitable to cause hardening of the polymeric material to form the polymeric coupling as a casting on the body.

22. A method according to claim 21, wherein the body is at least partially formed from metal.

23. A method according to claim 21, wherein the body surface is profiled so that the interface between the polymeric component and the section surface is tortuous.

24. A method according to claim 21, wherein the body is used in water infrastructure and a water impermeable interface is formed between the body surface and the polymeric component.

25. (canceled)

26. (canceled)
